(19) United States
(12) Patent Application Publication
(10) Pub. No.: US 2024/0320917 A1
(43) Pub. Date: Sep. 26, 2024

(54) DIFFUSION BASED CLOTH REGISTRATION

(71) Applicant: Meta Platforms Technologies, LLC, Menlo Park, CA (US)

(72) Inventors: Shunsuke Saito, Pittsburgh, PA (US); Jingfan Guo, Minneapolis, MN (US); Chenglei Wu, Pittsburgh, PA (US); Fabian Andres Prada, Pittsburgh, PA (US); Donglai Xiang, Pittsburgh, PA (US); Javier Romero, Madrid (ES); Takaaki Shiratori, Pittsburgh, PA (US); Hyun Soo Park, St. Paul, MN (US)

(21) Appl. No.: 18/609,050

(22) Filed: Mar. 19, 2024

Related U.S. Application Data
(60) Provisional application No. 63/454,000, filed on Mar. 22, 2023.

(51) Int. Cl. G06T 17/20

(52) U.S. Cl. CPC G06T 17/20; G06T 2210/16

(57) ABSTRACT

A method and system for cloth registration to improve modeling clothes by providing, for example, wrinkle-accurate cloth registration. The method includes obtaining an input scan of clothing in motion. The method includes generating a mesh representing the cloth in the scan based on a diffusion-based shape prior. The method includes registering a model of the cloth from the scan using a guidance process including at least: guiding deformation of the clothing based on a coarse registration signal based on the mesh and guiding the deformation of the clothing based on a distance between points in the mesh and a template mesh.

### CROSS-REFERENCE TO RELATED APPLICATIONS

The present disclosure is related and claims priority under 35 U.S.C. § 119(e) to U.S. Prov. Application No. 63/454,000, entitled DIFFUSION SHAPE PRIOR FOR WRINKLE-ACCURATE CLOTH REGISTRATION to SAITO, et-al., filed on Mar. 22, 2023, the contents of which are hereby incorporated by reference in their entirety, for all purposes.

### BACKGROUND

### Field

The present disclosure is generally related to registering clothing. More specifically, the present disclosure includes registering clothing with accurate deformations by leveraging a shape prior learned from pre-captured clothing using diffusion models.

### Related Art

Virtual presentations have become increasingly focal to social presence, self-expression through visual features, and the like. How we dress is important in the perception of identity. The digitization of dynamically deforming clothes is, therefore, a core aspect to enabling genuine social interaction in virtual environments. Digitization of clothes may be implemented in a myriad of applications including photorealistic telepresence, virtual try-on and visual effects for game and movies. Photorealistic appearance of clothes may be modeled using computer vision and graphics. However, there is a need for providing more accurate registration of clothing with large deformations (e.g., wrinkles).

### SUMMARY

The subject disclosure provides for systems and methods for cloth registration. Specifically, enabling accurate registrations of textureless clothes with large deformation by leveraging a shape prior learned from pre-captured clothing using diffusion models. The registration process is stably guided via a multi-stage guidance sampling process.

According to certain aspects of the present disclosure, embodiments includes a means for obtaining an input scan including at least cloth, a means for generating a mesh of the cloth in the scan based on a shape prior, and registering means for cloth registration comprising: guiding deformation of the cloth based on a coarse registration signal based on the mesh, and guiding the deformation of the cloth based on a distance between points in the mesh and a template mesh.

In one aspect of the present disclosure, the method includes obtaining an input scan including at least cloth, generating a mesh representing the cloth in the scan based on a shape prior, and registering a model of the cloth from the scan, the registering comprising: guiding deformation of the cloth based on a coarse registration signal based on the mesh, and guiding the deformation of the cloth based on a distance between points in the mesh and a template mesh.

Another aspect of the present disclosure relates to a system configured for cloth registration. The system includes one or more processors, and a memory storing instructions which, when executed by the one or more processors, cause the system to obtain an input scan including at least cloth, generate a mesh representing the cloth in the scan based on a shape prior, guide a first deformation of the cloth based on a coarse registration signal based on the mesh, guide a second deformation of the cloth based on a distance between points in the mesh and a template mesh, and register a model of the cloth from the scan based on the first deformation and the second deformation, wherein the first deformation corresponds to large deformations and the second deformation corresponds to detailed deformations.

Yet another aspect of the present disclosure relates to a non-transient computer-readable storage medium having instructions embodied thereon, the instructions being executable by one or more processors to perform a method(s) for cloth registration described herein. The method may include obtaining an input scan including at least clothing, generating a mesh representing the clothing in the scan based on a shape prior, guiding a first deformation of the clothing based on a coarse registration signal and 3D point cloud corresponding to the mesh, guiding a second deformation of the clothing based on a distance between points in the 3D point cloud and a template mesh, and registering a model of the clothing from the scan based on the first deformation and the second deformation, wherein the first deformation corresponds to large deformations and the second deformation corresponds to detailed deformations.

These and other embodiments will be evident from the present disclosure.

### BRIEF DESCRIPTION OF THE DRAWINGS

FIG. 1 illustrates a network architecture used for cloth registration, according to some embodiments.

FIG. 2 is a block diagram illustrating details of devices used in the architecture of FIG. 1, according to some embodiments.

FIGS. 3A-3C illustrate exemplary block diagrams of a model architecture used for providing deformation-accurate cloth registration, according to one or more embodiments.

FIG. 4 illustrates a forward process and reverse process of a diffusion model, according to some embodiments.

FIG. 5 illustrates seam stitching in UV parameterization used for mapping 3D meshes to 2D UV surfaces, according to some embodiments.

FIG. 6 illustrates 3D point cloud generation, according to some embodiments.

FIG. 7 is a block diagram illustrating an example system with which aspects of the subject technology can be implemented, according to some embodiments.

FIG. 8 illustrates an example flow diagram of a process for cloth registration, according to certain aspects of the disclosure.

FIG. 9 illustrates different techniques (with a t-shirt sequence): SyNoRiM, Laplacian, 3D-CODED, PCA, and compositional VAE techniques, and techniques according to embodiments compared to a ground-truth identity, according to some embodiments.

FIG. 10 illustrates different techniques (with a skirt sequence): SyNoRiM, Laplacian, 3D-CODED, PCA, and compositional VAE techniques, and techniques according to embodiments compared to a ground-truth identity, according to some embodiments.

FIG. 11 illustrates background ablation results, according to some embodiments.

FIG. 12 illustrates background ablation results, according to some embodiments.

FIG. 13 illustrates registrations using sparse ground-truth guidance, according to some embodiments.

FIG. 14 is a block diagram illustrating a computer system used to at least partially carry out one or more of operations in methods disclosed herein, according to some embodiments.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Virtual presentations have become increasingly focal to social presence, self-expression through visual features, and the like. How we dress is important in the perception of identity. The digitization of dynamically deforming clothes is, therefore, a core aspect to enabling genuine social interaction in virtual environments. Digitization of clothes may be implemented in a myriad of applications including photorealistic telepresence, virtual try-on and visual effects for game and movies. Photorealistic appearance of clothes may be modeled using computer vision and graphics. However, non-rigid 3D registration is a long-standing problem in the field of computer vision and graphics, resulting in the need for more accurate registration of cloth (e.g., clothing) with large deformations.

Surface registration may be used in modeling photorealistic appearance and geometric deformations by establishing correspondences between a template model and observed three-dimensional (3D) reconstruction at each time frame. However, traditional methods of surface registration suffer from in-plane sliding of the vertices due to the lack of geometric constraints, making the registration results unsuitable for learning clothes characteristics such as physical parameters or statistical models of deformations. To avoid sliding (e.g., in-plane sliding), these methods rely on texture, i.e., photometric consistency to establish correspondence between the template and the observed images. Due to the reliance on the texture, the performance of the registration is highly dependent on the uniqueness and contrast of the texture, making it unsuitable for regions without salient patterns. Textureless registration (e.g., regularizing deformations) do not transfer well to clothing because cloth deformation is highly complex, including stretching and bending, and additionally require hyper parameter tuning to achieve a balance between registration objective and regularization. Further, modeling large deformation and fine details of clothing simultaneously can be difficult.

Embodiments, as disclosed herein, provide a solution to the above-mentioned problems rooted in computer technology, namely, effectively leveraging a shape prior from real-world clothing deformations for cloth registration. To achieve this, embodiments as disclosed herein present a diffusion-based shape prior that can effectively encode highly complex clothing geometry. The cloth registration approach leverages the diffusion-based shape prior to achieve accurate cloth registration even in a textureless setting. The disclosed subject technology further provides improvements to the functioning of the computer itself because it achieves accurate registration of clothing under large motion even without texture information. Accordingly, improving the technological field as well provides photorealistic cloth registration with increased accuracy including, for example, wrinkle-accurate cloth registration.

According to embodiments, a diffusion model is employed to learn complex shape distributions of cloth from real pre-captured clothing. Diffusion models are a class of generative models that can learn the prior from highly complex data distributions by score matching. In embodiments, the diffusion model is used to estimate both deformation and detailed deformation in a unified model by integrating it into an optimized framework. Using real-world clothing to train the diffusion model provides an improved understanding of intricate deformations and interactions with human body parts, which are not precisely synthesized by physics-based simulation. In addition, learning the shape prior from real-world clothing deformations can constrain the solution space within the span of plausible clothing deformations, and also avoids heuristics and the need for parameter tuning.

According to embodiments, a multi-stage posterior sampling process based on learned functional maps is employed to stabilize registrations for large scale deformation, even when the deformations vary significantly from training data.

The multi-stage posterior sampling process may include, in the early stages, denoising which is guided by a learning-based coarse registration approach and, in the later stages includes refining with point-to-plane errors. In this way, the registration can avoid local minima while retaining high-fidelity cloth appearance (e.g., wrinkles) with faithful surface deformations.

According to embodiments, a ground-truth correspondence may be obtained by a tracking method based on clothes with a special printed pattern. The ground-truth correspondence may be used to evaluate the accuracy of surface registrations in real data based on the diffusion-based shape prior of embodiments. In some embodiments, garment-specific shape priors are directly learned from high-quality ground-truth (e.g., ground-truth 4D scans) to perform more accurate registration. Some embodiments also illustrate an evaluation of the ground-truth from a wide range of motions and contact of real clothes, quantitatively demonstrating the accuracy of several registration methods in real-world scenarios.

### Example Architecture

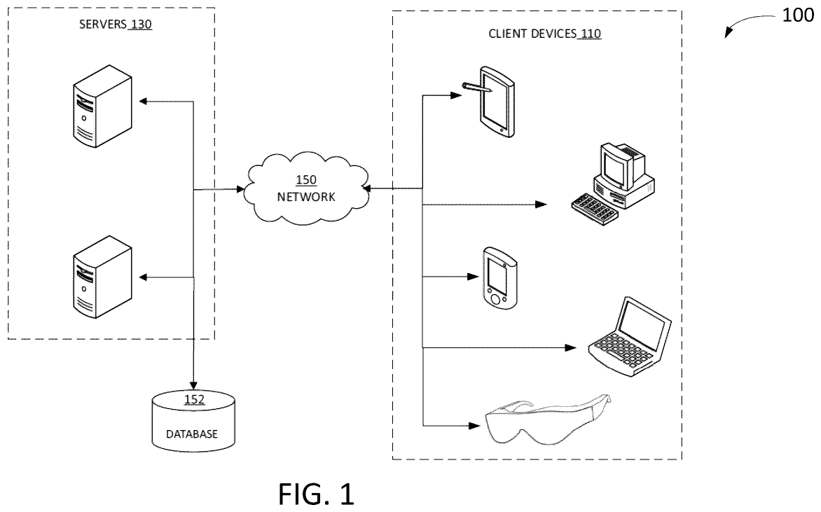

FIG. 1 illustrates a network architecture 100 used to implement cloth registration and reconstruction, according to some embodiments. Architecture 100 may include servers 130 and a database 152, communicatively coupled with multiple client devices 110 via a network 150. Any one of servers 130 may host a social platform running on client devices 110, used by one or more of the participants in the network. Client devices 110 may include any one of a laptop computer, a desktop computer, or a mobile device such as a smart phone, a palm device, video player, or a tablet device. In some embodiments, client devices 110 may include a headset or other wearable device (e.g., a virtual reality or augmented reality headset or smart glass), such that at least one participant may be running an immersive reality social platform installed therein. The database 152 may store backup files from the social platform, including threads, messages, videos, and metadata.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

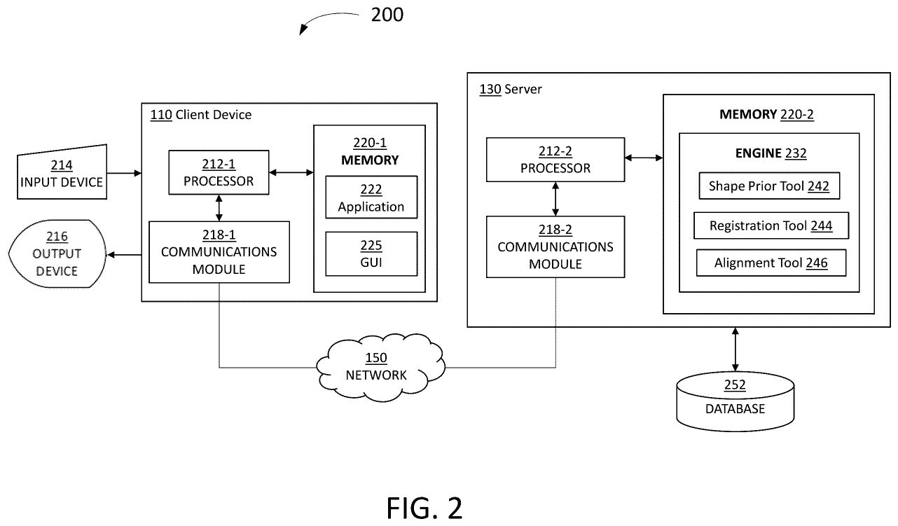

FIG. 2 is a block diagram 200 illustrating details of a client device 110 and a server 130 used in a network architecture as disclosed herein (e.g., architecture 100), according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency—RF—, near field communications—NFC—, Wi-Fi, and Bluetooth radio technology). Client device 110 may be coupled with an input device 214 and with an output device 216. A user may interact with client device 110 via the input device 214 and the output device 216. Input device 214 may include a mouse, a keyboard, a pointer, a touchscreen, a microphone, a joystick, a virtual joystick, a touch-screen display that a user may use to interact with client device 110, or the like. In some embodiments, input device 214 may include cameras, microphones, and sensors, such as touch sensors, acoustic sensors, inertial motion units—IMUs—and other sensors configured to provide input data to a VR/AR headset. Output device 216 may be a screen display, a touchscreen, a speaker, and the like.

Client device 110 may also include a processor 212-1, configured to execute instructions stored in a memory 220-1, and to cause client device 110 to perform at least some operations in methods consistent with the present disclosure. Memory 220-1 may further include an application 222 and a GUI 225, configured to run in client device 110 and couple with input device 214 and output device 216. The application 222 may be downloaded by the user from server 130 and may be hosted by server 130. The application 222 includes specific instructions which, when executed by processor 212-1, cause operations to be performed according to methods described herein. In some embodiments, the application 222 runs on an operating system (OS) installed in client device 110. In some embodiments, application 222 may run out of a web browser. In some embodiments, the processor is configured to control a graphical user interface (GUI) (e.g., via GUI 225) for the user of one of client devices 110 accessing the server of the social platform, immersive reality application, or the like.

A database 252 may store data and files associated with the social platform from the application 222. In some embodiments, client device 110 is a mobile phone used to collect a video or picture and upload to server 130 using a video or image collection application 222, to store in the database 252.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an engine 232. The engine 232 may share or provide features and resources to GUI 225, including multiple tools associated with image or video collection, capture, or design applications that use images or pictures (e.g., application 222) retrieved with engine 232. The user may access engine 232 through application 222, installed in a memory 220-1 of client device 110. Accordingly, application 222, including GUI 225, may be installed by server 130 and perform scripts and other routines provided by server 130 through any one of multiple tools. Execution of application 222 may be controlled by processor 212-1.

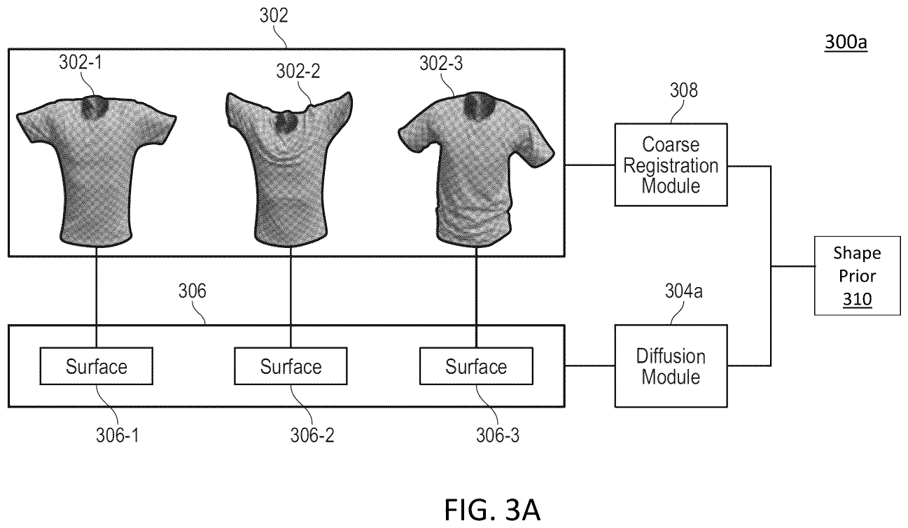

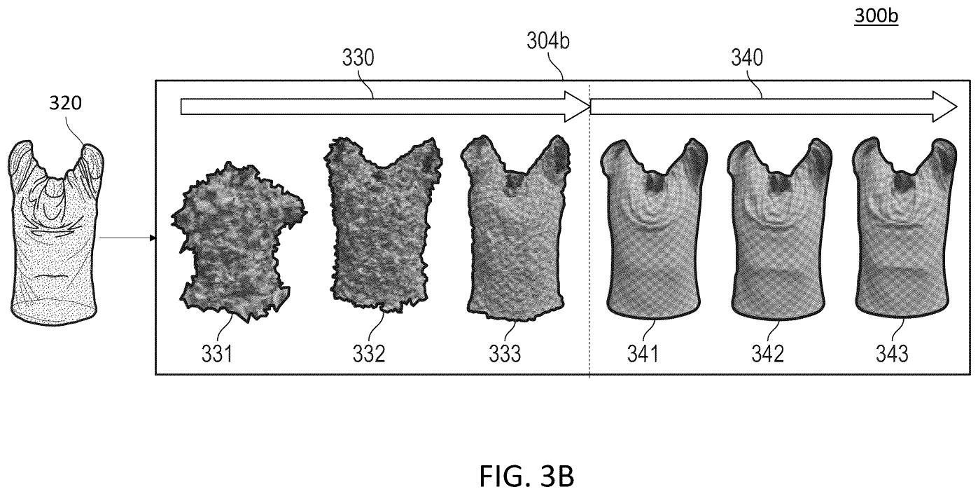

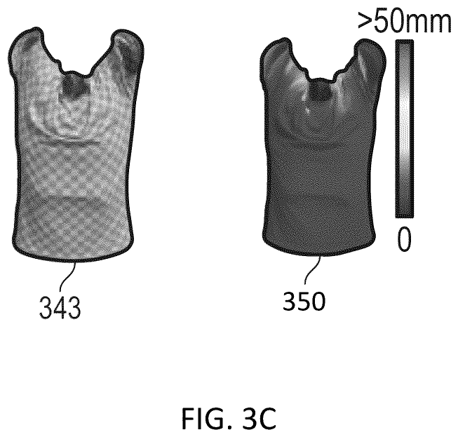

Engine 232 may include one or more modules (e.g., modules later described with reference to system 300 in FIG. 3) configured to perform operations according to one or more aspects of embodiments described herein. The engine 232 may share or provide features and resources to GUI 225, including multiple tools associated with training and using a diffusion model for accurate cloth registration (e.g., applied to application 222). Engine 232 may include a shape prior tool 242, registration tool 244, and alignment tool 246 which, in one or more combinations of tools, are configured to learn a strong shape prior from pre-captured 4D data using a diffusion model and apply it to textureless registration of the clothing with complex deformations.

The shape prior tool 242 may be configured to learn, for example, given ground-truth 4D scans of cloth in motion, a shape prior using the diffusion model to simultaneously encode large deformation and fine details. The registration tool 244 can use the learned shape prior to register the same clothing to noisy 4D scans via a multi-stage manifold guidance process. In some embodiments, in a first stage of the multi-stage manifold guidance, the shape prior relies on a coarse registration signal to achieve rough alignment. By non-limiting example, the coarse registration signal may be acquired by markers, visual-based tracking, geometric-based tracking, or any combination of them. In some implementations, the coarse registration signal may be acquired based on geometric information. The alignment tool 246, in a second stage of manifold guidance, uses the shape prior to further refine the alignment of the cloth registration to achieve wrinkle-accurate registration by considering spatial proximity based on the 4D scans.

The engine 232 may include a neural network tool which may be part of one or more machine learning models stored in the database 252. The database 252 includes training archives and other data files that may be used by engine 232 in the training of a machine learning model, according to the input of the user through application 222. Moreover, in some embodiments, at least one or more training archives or machine learning models may be stored in either one of memories 220. The neural network tool may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, the database 252 may include a training archive to modify coefficients according to a desired outcome of the machine learning model. Accordingly, in some embodiments, engine 232 is configured to access database 252 to retrieve documents and archives as inputs for the machine learning model. In some embodiments, engine 232, the tools contained therein, and at least part of database 252 may be hosted in a different server that is accessible by server 130 or client device 110.

FIGS. 3A-3C illustrate block diagrams of a model architecture used for providing deformation-accurate cloth registration, according to one or more embodiments. FIG. 3A illustrates a first stage of the model architecture comprising a training phase 300a including, for example, training a diffusion module 304a and coarse registration module 308. FIG. 3B illustrates a second stage of the model architecture comprising an inference phase 300b including, for example, testing the diffusion module 304b. The diffusion module 304a (in training phase) and diffusion module 304b (in testing phase) are hereafter collectively referred to as “diffusion modules 304.”

According to embodiments, cloth is registered based on ground-truth 4D scans 302-1, 302-2, and 302-3 (hereafter simply referenced as “scans 302”) of cloth in motion. The scans 302 are used to train the diffusion module 304a. Embodiments are not limited to this and the training dataset may include, for example, an image or video dataset comprising clothing and/or pattern-based cloth registration datasets that provide a template geometry for each clothing type, as well as accurate registrations in the same topology.

The cloth geometry in the scans 302 may be represented as a 3D triangle mesh (with V vertices [symbol] ∈ [symbol] ^{V×3} and F triangles), where the i-th vertex position is denoted as vᵢ. According to embodiments, the scans 302 are mapped to mesh 2D ultraviolet (UV) surfaces 306-1, 306-2, and 306-3 (hereinafter, collectively referred to as “surfaces 306”). For each scan, there exists a surjective map from a 3D vertex index to a 2D UV surface (i.e., u=ϕ(i)) where every 3D vertex index maps to at least one coordinate of the 2D UV surface. The surfaces 306 are used, by diffusion module 304a, to learn a diffusion-based shape prior. In some embodiments, the surfaces 306 are represented as 3D point clouds.

According to embodiments, a displacement of the surfaces 306 may be defined from a mean template shape with vertices [symbol] as a function of a UV coordinate (i.e., [symbol] |ᵤ=vᵢ−v̅ᵢ̅, where v̅ᵢ̅ is the i-th vertex of the mean template shape, and [symbol] |ᵤ is the displacement map evaluated at u). In simplified terms (e.g., with an abuse of notation), the displacement mapping may be denoted as [symbol] =Φ( [symbol] ) and the inverse displacement mapping may be denoted as [symbol] =Ψ( [symbol] ). In some implementations, a vertex of the mean template shape may map to multiple points in displacement map [symbol] . The multiple points may lie in the boundary (e.g., the seams) of the unwrapped clothes.

The coarse registration module 308 generates a coarse registration signal based on the surfaces 306. The coarse registration signal may correspond to a registered point cloud. Registering cloth using the coarse registration signal further improves the accuracy and regularizes the deformations. The coarse registration module 308 is trained based on the mean template shape and random sub-sampling on mesh vertices of the surfaces 306. The coarse registration module 308 learns to predict per-vertex 3D flow from the mean template shape to a target shape given the 3D point clouds (of surfaces 306) as input. In some embodiments, where markers or visual information are not available, the coarse registration module 308 is trained to establish a putative correspondence between each 3D point cloud pair estimate a set of functions Φₖ for each 3D point cloud. The coarse registration module 308 jointly models the correspondences between each 3D point cloud pair and the set of functions Φₖ to obtain a functional map [symbol] . During test time with multiple inputs, the coarse registration module 308 estimates a map set for all pairs and registers cloth based on the learned functional maps.

The diffusion module 304a is configured to train a diffusion-based model to learn a shape deformation space based on the surfaces 306. The diffusion-based model can then generate plausible shape deformations. According to some embodiments, learning the shape deformation space includes learning a prior distribution of deformation such that a random sampling in the distribution leads to accurate deformation predictions. The diffusion-based model may include forward and reverse diffusion processes.

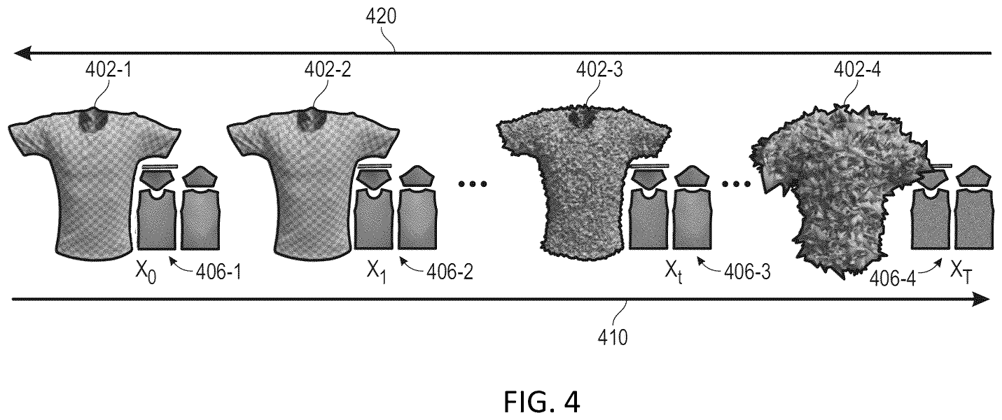

FIG. 4 is an illustration of the forward process 410 and reverse process 420 of the diffusion model, according to one or more embodiments. The forward process 410 and reverse process 420 are used for training models according to aspects of embodiments.

In the forward process 410, noise is gradually added to the UV displacement map (x₀) to acquire an isotropic Gaussian distribution (x_{T}). As shown in FIG. 4, noise is added at each time stamp as illustrated by 3D scans 402-1, 402-2, 402-3, and 402-4 having increased noise moving in the forward process 410 direction. Each of the 3D scans 402-1, 402-2, 402-3, and 402-4 are illustrated with their exemplary corresponding 2D UV surfaces 406-1, 406-2, 406-3, and 406-4. The added noise is apparent in the illustration of the 2D UV surfaces 406-1, 406-2, 406-3, and 406-4, gradually increasing from left to right. The forward process 410 (i.e., q(xₜ|xₜ₋₁)) includes learning a transition probability from the complete coarse registration signal to a random noise (e.g., x_{T}) by adding the noise:

$$\begin{matrix}{x}_{t} = \sqrt{1 - {β}_{t}} {x}_{t - 1} + {β}_{t} ϵ , & {x}_{0} = 𝒰\end{matrix} \qquad Equation ( 1 )$$

where ϵ˜ [symbol] (0,1) is a sample from the Gaussian distribution and βₜ is the variance schedule. To ensure coarse-to-fine shape learning, the variance schedule βₜ is gradually increased by increasing t. According to Equation (1), increasing t reduces the impact of xₜ₋₁ while increasing the impact of Gaussian noise, ensuring the coarse-to-fine shape learning where large deformation (low-frequency) is modeled at large t (later diffusion stage), and small deformation (high-frequency) is modeled at small t.

In the reverse process 420, the UV displacement map x₀ is recovered in order to sample from the learned prior distribution of deformation by gradually denoising a corrupted UV displacement map. As shown in FIG. 4, 3D scans 402-1, 402-2, 402-3, and 402-4 are denoised as illustrated by the decreasing noise in the scans when moving in the reverse process direction. According to embodiments, the coarse registration signal is reconstructed from the random noise E by denoising. The denoising is defined by:

$${x}_{t - 1} = \frac{1}{\sqrt{{α}_{t}}} ( {x}_{t} - \frac{1 - {α}_{t}}{\sqrt{1 - {\overline{α}}_{t}}} {ϵ}_{θ} ( {x}_{t} , t ) ) + {σ}_{t} z \qquad Equation ( 2 )$$

The denoising, in accordance with Equation (2), is an ancestral sampling operation wherefrom a plausible data sample of the UV displacement map x₀ is generated by iterating through xₜ₋₁ from the learned prior (e.g., shape prior 310). Based on the variance schedule βₜ, the following are defined as:

$${α}_{t} = 1 - {β}_{t} , {\overline{α}}_{t} = {\prod }_{i = 1}^{t} {α}_{i} , and {σ}_{t} = \sqrt{{\tilde{β}}_{t}} = \sqrt{\frac{1 - {\overline{α}}_{t - 1}}{1 - {\overline{α}}_{t}} {β}_{t}} .$$

The learnable neural network ϵ_{θ} parameterized by θ aims to predict the noise ϵ from corrupted data. In some embodiments, the diffusion module 304a trains the neural network ϵ₀ with a weighted variational bound as the objective defined as:

$$L = {𝔼}_{t , {x}_{0} , ϵ} [ {‖ ϵ - {ϵ}_{θ} ( \sqrt{{\overline{α}}_{t}} {x}_{0} + \sqrt{1 - {\overline{α}}_{t}} ϵ , t ) ‖}^{2} ] \qquad Equation ( 3 )$$

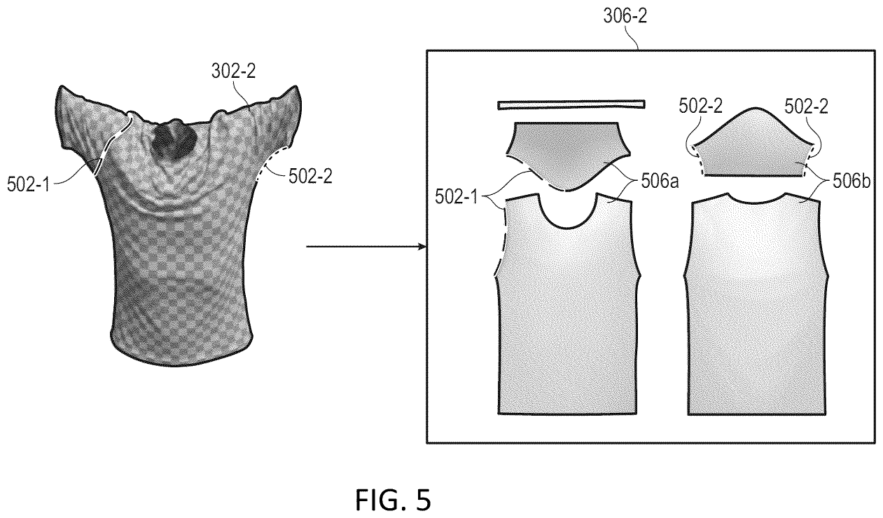

FIG. 5 illustrates seam stitching in UV parameterization used for mapping 3D meshes (e.g., scans 302) to 2D UV surfaces (e.g., surfaces 306), according to one or more embodiments. The UV parameterization may be performed to generate the surfaces 306 by mapping the 3D vertex index to a corresponding point on a 2D UV surface. As shown in FIG. 5, scan 302-2 is cut along the seams (e.g., seams 502-1, 502-2) in the UV parameterization. In this manner, 3D surface 306-2 is generated (with a front view 506a and rear view 506b of the surface 306-2 illustrated in FIG. 5) as a plausible clothing shape with a smooth surface that maps to smoothly transitioned values across the seams 502-1, 502-2 based on scan 302-2.

According to embodiments, seam stitching is performed to avoid clothing being separated apart at the seam. In some embodiments, the clothing may be stitched at the seam at every time step in the reverse process 420 (i.e., x′ₜ₋₁=Φ(Ψ(xₜ₋₁))). The mapping from UV to mesh space is not injective. As such, ambiguities may be solved by averaging the 3D locations of UV positions which refer to the same point/UV coordinate.

Returning to FIG. 3A, the coarse registration signal of the coarse registration module 308 and the shape deformation space of the diffusion module 304a are used to generate a diffusion-based shape prior 310 that may be used to generate, at inference, cloth registrations with plausible deformations.

FIG. 3B illustrates the inference phase 300b of the diffusion module 304b. The diffusion module 304b may implement a guidance framework to register cloth (e.g., manifold guidance). The guidance framework may include coarse registration guidance 330 and spatial proximity guidance 340 stages. The coarse registration guidance 330, spatial proximity guidance 340, and the reverse process 420 are used at inference to register a cloth. The guidance framework performs non-rigid registration tasks with increased accuracy and superior performance with multiple clothing types and diverse motions.

According to some embodiments, the coarse registration guidance 330 leverages the coarse registration signal to identify an alignment of cloth registration. As shown in FIG. 3B, the 3D scans 331, 332, and 333 illustrate gradual denoising to generate the rough alignment based on an input 4D scan 320. According to some embodiments, the spatial proximity guidance 340 leverages the shape prior 310 to further refine the alignment and generate a model of the cloth by considering spatial proximity of the input 4D scan 320. As shown in FIG. 3B, scans 341 and 342 illustrate gradual refinement resulting in a model 343 which accurately registers the same clothing to noisy 4D scans. FIG. 3C illustrates a heat map 350 of the model 343 demonstrating error metrics measured in millimeters (mm). As shown in FIG. 3C, the registration or model 343 results in minimal error and increased accuracy based on input 4D scan 320.

As described with reference to FIG. 4, the sampling in the reverse process 420 allows generating plausible shape deformation. Returning to FIG. 3B, assuming the gradient of log marginal density can be approximated by a learned network (∇ₓ_{ₜ} log p(xₜ)≅−ϵ_{θ}/σₜ), the guidance framework maximizes the log-likelihood of every diffusion state (xₜ), given the observation [symbol] ∈ [symbol] ^{P×3} where P is the number of observed 3D points, as follows:

$${∇}_{{x}_{t}} log p ( {x}_{t} \vert 𝒴 ) ≃ - \frac{{ϵ}_{θ} ( {x}_{t} , t )}{{σ}_{t}} - ρ {∇}_{{x}_{t}} d ( {\hat{x}}_{0} , 𝒴 ) \qquad Equation ( 4 )$$

where d is a multi-stage distance measurement in Euclidean space, and ρ is the step size of guidance. The posterior mean \hat{x}₀ can be estimated from xₜ, where:

$${\hat{x}}_{0} = \frac{1}{\sqrt{{\overline{α}}_{t}}} {x}_{t} - \sqrt{\frac{1 - {\overline{α}}_{t}}{{\overline{α}}_{t}}} {ϵ}_{θ} ( {x}_{t} , t ) \qquad Equation ( 5 )$$

Guidance parameters of the coarse registration guidance 330 and the spatial proximity guidance 340, based on the distance measurement d with the decreasing time step t in the reverse diffusion process, can be defined by:

$$d ( {\hat{x}}_{0} , 𝒴 ) = \{ \begin{matrix}{\sum }_{i = 1}^{V} {‖ {\tilde{v}}_{i} - {\hat{v}}_{i} ‖}^{2} & t > τ \\ {\sum }_{i = 1}^{P} {‖ ( {y}_{i} - ℜ ( \hat{V} , {y}_{i} ) ) {n}_{{y}_{i}}^{T} ‖}^{2} & t \leq τ\end{matrix} \qquad Equation ( 6 )$$

where \tilde{v}ᵢ is the target position predicted by the coarse registration module 308 (i.e., [symbol] ( [symbol] )). The mesh vertices are mapped from the UV displacement map as [symbol] =Φ(\hat{x}₀) with the i-th vertex denoted as \hat{v}ᵢ. The time step i is the point where the distance measurement is changed. [symbol] retrieves the closest point in [symbol] and n_{y}_{ᵢ}∈ [symbol] ³ is the normal vector of yᵢ.

According to some embodiments, when t>τ, the coarse registration guidance 330 uses the coarse registration signal generated by coarse registration module 308 to guide large deformations of the clothing shape. The coarse registration signal is used (at coarse registration guidance 330) to guide the large deformations until a rough alignment with the input 3D point cloud is achieved. After t≤τ, the vertices are guided at the spatial proximity guidance 340 by point-to-plane errors based on spatial proximity from the point yᵢ. Using a point-to-plane distance helps to avoid overestimating the distance measurement d when the input point cloud contains holes.

In some embodiments, after reaching t=0 in the reverse process 420, the final denoising step is repeated with point-to-plain guidance to adjust the inferred vertices to the high-frequency surface details of the point cloud.

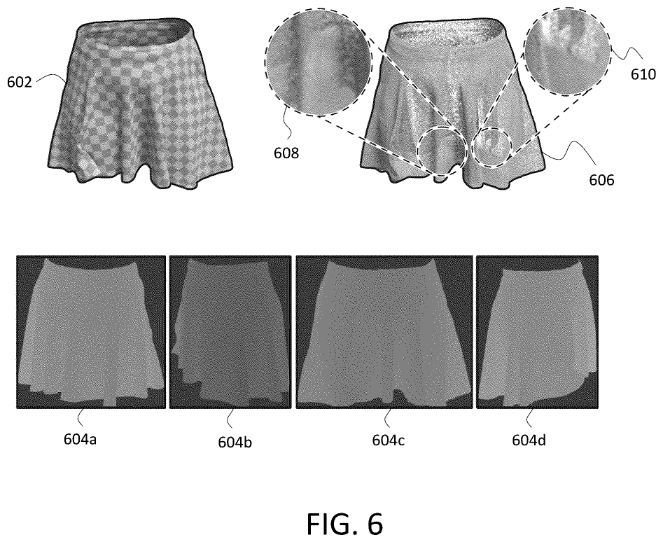

FIG. 6 illustrates 3D point clouds generated to mimic a 3D reconstruction acquired by a 3D capture system. In some implementations, original point clouds are not included in datasets, and as such a partial 3D reconstruction is generated to be used as input at test time. Multi-view depth images are rendered using ground-truth registration (e.g., for ground-truth meshes from side and top views). As shown in FIG. 6, depth images 604a-604d (hereafter, collectively referred to as “depth images 604”) are rendered based on registration 602. The depth images 604 are then fused into a 3D point cloud 606 with proper occlusion and deformation reasoning, as shown in zoomed-in view 608 and zoomed-in view 610. The 3D point cloud 606 may be sub-sampled for testing.

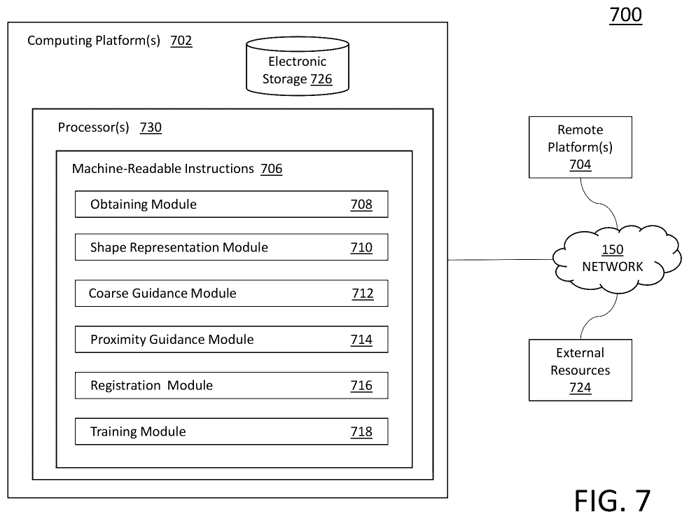

FIG. 7 is a block diagram illustrating an example system 700 (e.g., representing both client and server) with which aspects of the subject technology can be implemented. The system 700 may be configured for registering wrinkle-accurate cloth, according to certain aspects of the disclosure. In some implementations, the system 700 may include one or more computing platforms 702. The computing platform(s) 702 can correspond to a server component of an artificial reality, extended reality, or extra reality (collectively “XR”), or other communication platform, which can be similar to or the same as the server 130 of FIG. 2 and include the processor 212-2. XR is a form of reality that has been adjusted in some manner before presentation to a user, which may include, e.g., virtual reality (VR), augmented reality (AR), mixed reality (MR), hybrid reality, or some combination and/or derivatives thereof. For example, the computing platform(s) 702 may be configured to execute software algorithm(s) to generate cloth registrations and/or cloth reconstructions for rendering in an XR application or the like.

The computing platform(s) 702 can maintain or store data, such as in the electronic storage 726, including correlation and contextual data used by the computing platform(s) 702. The computing platform(s) 702 may be configured to communicate with one or more remote platforms 704 according to a client/server architecture, a peer-to-peer architecture, and/or other architectures. The remote platform(s) 704 may be configured to communicate with other remote platforms via computing platform(s) 702 and/or according to a client/server architecture, a peer-to-peer architecture, and/or other architectures. The remote platform(s) 704 can be configured to cause output of the system 700 on client device(s) of the remote platform(s) 704 with enabled access.

The computing platform(s) 702 may be configured by machine-readable instructions 706. The machine-readable instructions 706 may be executed by the computing platform(s) to implement one or more instruction modules. The instruction modules may include computer program modules. The instruction modules being implemented may include one or more of obtaining module 708, shape representation module 710, coarse guidance module 712, proximity guidance module 714, registration module 716, training module 718 and/or other instruction modules.

The obtaining module 708 may be configured to obtain input 4D scans. The scans may be of a cloth in motion captured by at least one camera or scanning device (e.g., client device 110). According to some embodiments, the cloth may be textureless.

The shape representation module 710 may be configured to generate a mesh representing the cloth in the scan based on a shape prior using UV parameterization. The shape prior is trained to encode highly complex clothing geometry, as described herein. According to embodiments, the shape prior is learned from pre-captured clothing using a diffusion model. The mesh is represented as a 3D point cloud. In some embodiments, a displacement map is generated mapping 3D vertex indices of the mesh to a 3D UV surface based on a mean shape, each vertex index of the mesh to one or more points in a 3D surface. A point-to-plane distance measurement from the mesh (e.g., points of the 3D point cloud) to the mean shape may be determined based on the 3D surface of the input scan.

The coarse guidance module 712 may be configured to, based on the mesh, guide deformations of a model of the cloth based on a coarse registration signal until an alignment between the model and the mesh reaches a threshold.

In some embodiments, the system 700 may include, as input, a time step corresponding to the point where the distance between points in the mesh and a template (mean shape) changes. Given a current time step, a distance (e.g., point-to-point/point-to-plane) is measured and displacements are updated to minimize error.

In some embodiments, the system 700 may include a coarse signal generation module configured to generate the coarse registration signal by predicting per-vertex 3D flow from the template shape to a target shape (e.g., the cloth) given a 3D point cloud as input (e.g., the mesh).

The proximity guidance module 714 may be configured to guide deformations of the model by point-to-plane errors based on spatial proximity from points on the displacement map. For example, given a current time step, a distance measurement change is determined, and the vertices of the mesh are guided by point-to-plane errors.

The registration module 716 may be configured to register the model of the cloth from the scan based on the guided deformations providing non-rigid 3D, deformation (e.g., wrinkle) accurate cloth registration.

The training module 718 may be configured to train the diffusion model generating the shape prior based on 4D scans of clothing from a dataset. The training may include generating a mesh representation of the 4D scans. The system 700 may be further configured to gradually add random noise to the mesh to generate a corrupted UV map, wherein gradually adding the noise trains the model to learn a transition probability based on the mesh and the random noise. A variance schedule may be increased as the random noise is added. The system 700 may be further configured to reconstructing the mesh from the random noise. The reconstructing may include denoising based on the variance schedule. Denoising may include predicting the random noise from the corrupted UV map using a neural network trained with a weighted variational bound. The reconstructed mesh may be used to generate shape deformations for cloth registration.

In some implementations, the computing platform(s) 702, the remote platform(s) 704, and/or the external resources 724 may be operatively linked via one or more electronic communication links. For example, such electronic communication links may be established, at least in part, via, e.g., the network 150 such as the Internet and/or other networks. It will be appreciated that this is not intended to be limiting, and that the scope of this disclosure includes implementations in which the computing platform(s) 702, the remote platform(s) 704, and/or the external resources 724 may be operatively linked via some other communication media.

A given remote platform 704 may include client computing devices, such as the client device 110, which may each include one or more processors configured to execute computer program modules (e.g., the instruction modules). The computer program modules may be configured to enable an expert or user associated with the given remote platform 704 to interface with the system 700 and/or external resources 724, and/or provide other functionality attributed herein to remote platform(s) 704. By way of non-limiting example, a given remote platform 704 and/or a given computing platform 702 may include one or more of a server, a desktop computer, a laptop computer, a handheld computer, a tablet computing platform, a NetBook, a Smartphone, a gaming console, and/or other computing platforms. The external resources 724 may include sources of information outside of the system 700, external entities participating with the system 700, and/or other resources. For example, the external resources 724 may include externally designed XR elements and/or XR applications designed by third parties. In some implementations, some or all of the functionality attributed herein to the external resources 724 may be provided by resources included in system 700.

Computing platform(s) 702 may include electronic storage 726, one or more processors 730, and/or other components. Computing platform(s) 702 may include communication lines, or ports to enable the exchange of information with a network and/or other computing platforms. Illustration of the computing platform(s) 702 in FIG. 7 is not intended to be limiting. The computing platform(s) 702 may include a plurality of hardware, software, and/or firmware components operating together to provide the functionality attributed herein to the computing platform(s) 702. For example, the computing platform(s) 702 may be implemented by a cloud of computing platforms operating together as the computing platform(s) 702.

Electronic storage 726 may comprise non-transitory storage media that electronically stores information. The electronic storage media of electronic storage 726 may include one or both of system storage that is provided integrally (i.e., substantially non-removable) with computing platform(s) 702 and/or removable storage that is removably connectable to computing platform(s) 702 via, for example, a port (e.g., a USB port, a firewire port, etc.) or a drive (e.g., a disk drive, etc.). Electronic storage 726 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 726 may include one or more virtual storage resources (e.g., cloud storage, a virtual private network, and/or other virtual storage resources). Electronic storage 726 may store software algorithms, information determined by processor(s) 730, information received from computing platform(s) 702, information received from remote platform(s) 704, and/or other information that enables computing platform(s) 702 to function as described herein.

Processor(s) 730 may be configured to provide information processing capabilities in computing platform(s) 702. As such, processor(s) 730 may include one or more of a digital processor, an analog processor, a digital circuit designed to process information, an analog circuit designed to process information, a state machine, and/or other mechanisms for electronically processing information. Although processor(s) 730 is shown in FIG. 7 as a single entity, this is for illustrative purposes only. In some implementations, processor(s) 730 may include a plurality of processing units. These processing units may be physically located within the same device, or processor(s) 730 may represent processing functionality of a plurality of devices operating in coordination. Processor(s) 730 may be configured to execute modules 708, 710, 712, 714, 716 and/or 718, and/or other modules. Processor(s) 730 may be configured to execute modules 708, 710, 712, 714, 716 and/or 718, and/or other modules by software; hardware; firmware; some combination of software, hardware, and/or firmware; and/or other mechanisms for configuring processing capabilities on processor(s) 730. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 708, 710, 712, 714, 716 and/or 718 are illustrated in FIG. 7 as being implemented within a single processing unit, in implementations in which processor(s) 730 includes multiple processing units, one or more of modules 708, 710, 712, 714, 716 and/or 718 may be implemented remotely from the other modules. The description of the functionality provided by the different modules 708, 710, 712, 714, 716 and/or 718 described below is for illustrative purposes, and is not intended to be limiting, as any of modules 708, 710, 712, 714, 716 and/or 718 may provide more or less functionality than is described. For example, one or more of modules 708, 710, 712, 714, 716 and/or 718 may be eliminated, and some or all of its functionality may be provided by other ones of modules 708, 710, 712, 714, 716 and/or 718. As another example, processor(s) 730 may be configured to execute one or more additional modules that may perform some or all of the functionality attributed below to one of modules 708, 710, 712, 714, 716 and/or 718.

The techniques described herein may be implemented as method(s)/process(es) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

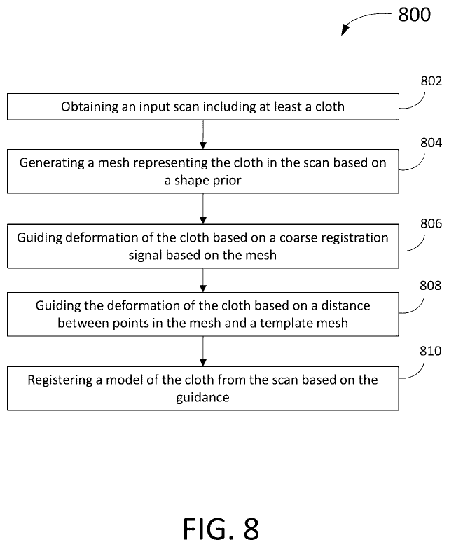

FIG. 8 illustrates an example flow diagram (e.g., process 800) for cloth registration, according to certain aspects of the disclosure. For explanatory purposes, the example process 800 is described herein with reference to one or more of the figures above. Further for explanatory purposes, the steps of the example process 800 are described herein as occurring in serial, or linearly. However, multiple instances of the example process 800 may occur in parallel.

At step 802, the process 800 may include obtaining an input scan including at least a cloth. At step 804, the process 800 may include generating a mesh representing the cloth in the scan based on a shape prior. According to an aspect of embodiments, the shape prior is a diffusion-based shape prior learned from pre-captured 4D data. According to an aspect of embodiments, the mesh is represented as a 3D point cloud and each vertex index of the 3D point cloud is mapped to one or more points in a 3D surface, wherein the distance from the mesh to the template mesh corresponding to the mean shape is based on the 3D surface.

At step 806, the process 800 may include guiding deformation of the cloth based on a coarse registration signal based on the mesh. According to an aspect of embodiments, the deformation of the cloth is guided based on the coarse registration signal until an alignment of a model registration of the cloth with the mesh reaches a threshold. According to an aspect of embodiments, the coarse registration signal is generated by predicting per-vertex 3D flow from a mean template shape to the cloth based on the mesh.

At step 808, the process 800 may include guiding the deformation of the cloth based on a distance between points in the mesh and a template mesh refining the model based on point-to-plane errors. The guidance in steps 806/808 may be posterior sampling processes, as described herein.

At step 810, the process 800 may include registering the model of the cloth from the scan based on the guidance (at step 806 and step 808). As such, the model registration of the cloth is based on a multistage guidance scheme and accounts for both large deformation and detailed deformation by using the shape prior to further refine the alignment, achieving wrinkle-accurate registration by considering spatial proximity with the input scan.

Although FIG. 8 shows example blocks of the process 800, in some implementations, the process 800 may include additional blocks, fewer blocks, different blocks, or differently arranged blocks than those depicted in FIG. 8.

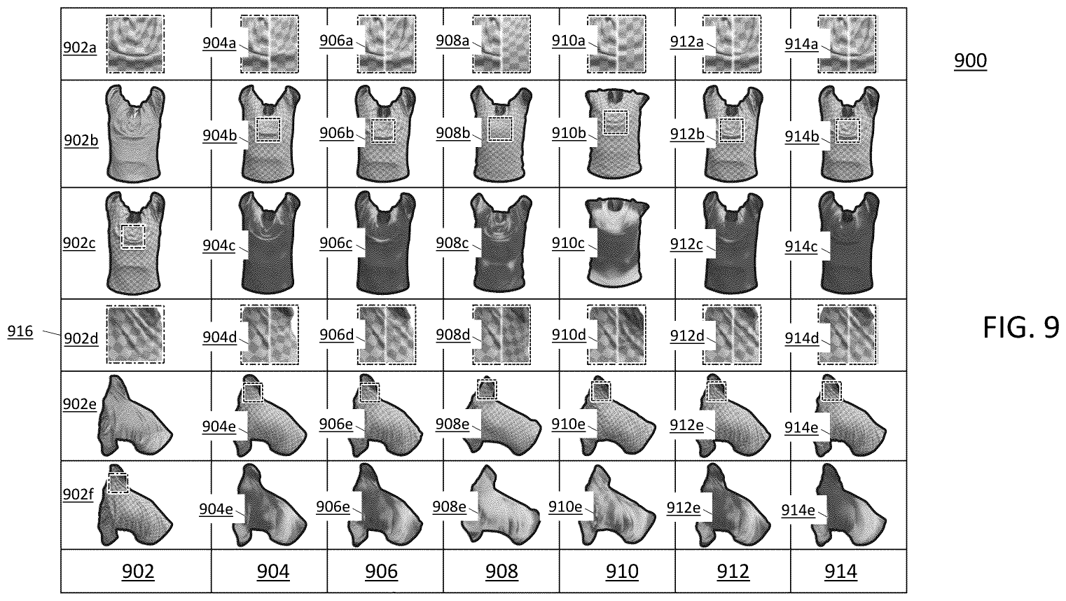

FIG. 9 illustrates t-shirt sequence registrations 902a, 902b, 902c, 902d, 902e, and 902f (hereinafter, collectively referred to as “input point cloud ground-truth registrations 902”), registrations 904a, 904b, 904c, 904d, 904e, and 904f (hereinafter, collectively referred to as “SyNoRiM registrations 904”), registrations 906a, 906b, 906c, 906d, 906e, and 906f (hereinafter, collectively referred to as “Laplacian registrations 906”), registrations 908a, 908b, 908c, 908d, 908e, and 908f (hereinafter, collectively referred to as “3D-coded registrations 908”), registrations 910a, 910b, 910c, 910d, 910e, and 910f (hereinafter, collectively referred to as “PCA registrations 910”), registrations 912a, 912b, 912c, 912d, 912e, and 912f (hereinafter, collectively referred to as “compositional VAE registrations 912”), and registrations 914a, 914b, 914c, 914d, 914e, and 914f (hereinafter, collectively referred to as “diffusion model registrations 914”). The registrations 902, 904, 906, 908, 910, 912, and 914 are collectively referred to as “registrations 900.”

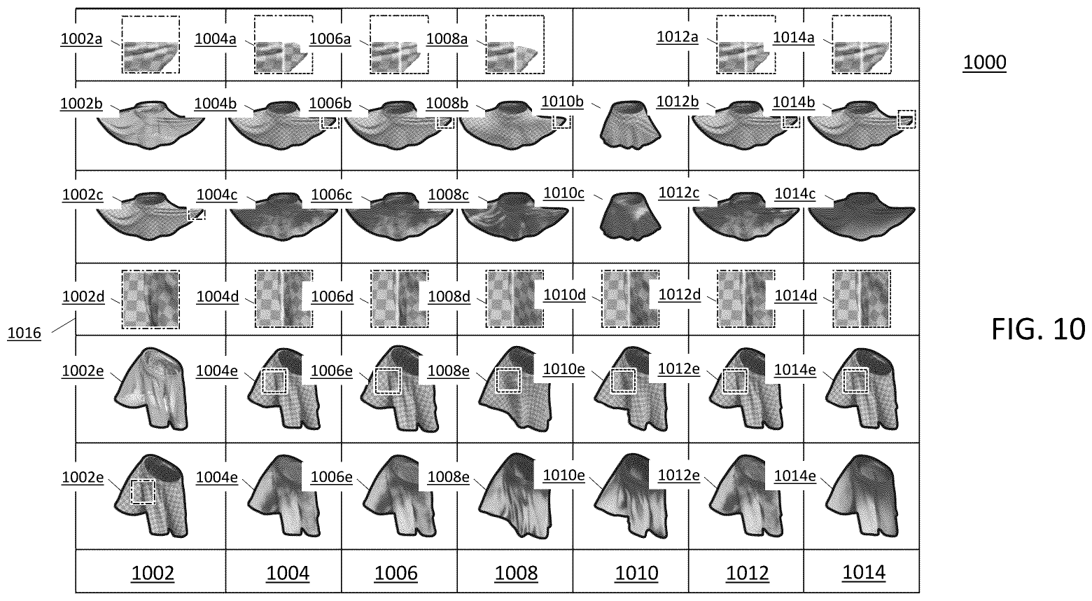

FIG. 10 illustrates skirt sequence registrations 1002a, 1002b, 1002c, 1002d, 1002e, and 1002f (hereinafter, collectively referred to as “ground-truth registrations 1002”), registrations 1004a, 1004b, 1004c, 1004d, 1004e, and 1004f (hereinafter, collectively referred to as “SyNoRiM registrations 1004”), registrations 1006a, 1006b, 1006c, 1006d, 1006e, and 1006f (hereinafter, collectively referred to as “Laplacian registrations 1006”), registrations 1008a, 1008b, 1008c, 1008d, 1008e, and 1008f (hereinafter, collectively referred to as “3D-coded registrations 1008”), registrations 1010b, 1010c, 1010d, 1010e, and 1010f (hereinafter, collectively referred to as “PCA registrations 1010”), registrations 1012a, 1012b, 1012c, 1012d, 1012e, and 1012f (hereinafter, collectively referred to as “compositional VAE registrations 1012”), and registrations 1014a, 1014b, 1014c, 1014d, 1014e, and 1014f (hereinafter, collectively referred to as “diffusion model registrations 1014”). The registrations 1002, 1004, 1006, 1008, 1010, 1012, and 1014 are collectively referred to as “registrations 1000.”

Referring to FIGS. 9-10, ground-truth registrations 902/1002 are the input point cloud registrations. SyNoRiM registrations 904/1004 are generated using general purpose non-rigid registration methods. Laplacian registrations 906/1006 are generated using heuristic shape-priors. 3D-coded registrations 908/1008 are generated by modeling 3D point translation and 3D patch deformation models following the original setting. PCA registrations 910/1010 are generated based on a Principal Component Analysis (PCA) technique and modeling per-vertex 3D displacement from mean template shape and keeping a number of principal components that retain at least 95% explained variance. Compositional VAE registrations 912/1012 are generated based on Variational Autoencoders (VAE) and modeling the UV displacement map based on UV parameterization.

In registrations 900/1000, the middle-left (row 916/1016) is the input point cloud, the bottom-left is the ground-truth, and the top-left is a zoom-in view of ground-truth. The rest are the results of different methods, where the top row shows side-by-side comparison to ground-truth, the middle row shows the geometry with normal rendering, while the bottom row shows vertex error Eᵥ (0 mm>50 mm) in a heat map.

Diffusion model registrations 914/1014 are generated with the diffusion-based model, described in model architecture 300, according to embodiments. As shown in FIGS. 9-10, the diffusion model registrations 914/1014 consistently produces better registration with lower vertex error and realistic wrinkles. Embodiments outperform both optimization-based and learning-based non-rigid registration methods for both interpolation and extrapolation tests.

Table 1 below is a comparison (where bold indicates the best results and bold italic indicates the second best results) of the performance of registrations 900 and registrations 1000 using different metrics (measured in mm). In Table 1, for each data sequence, the frames are split into training set and testing set, which further includes interpolation and extrapolation sets. The ground-truth registrations 902/1002 data is used as ground-truth for both training and testing. The interpolation testing set is uniformly sampled from the entire sequence, so its data distribution is similar to the training set. The extrapolation testing set is a manually selected short sequence consisting of body poses unseen in the training set.

TABLE 1
Quantitative Comparison of T-Shirt and Shirt Sequence Registrations

| | T-shirt | | | | Skirt | | | |
|---|---|---|---|---|---|---|---|---|
| | Interpolation set | | Extrapolation set | | Interpolation set | | Extrapolation set | |
| | Eᵥ | Eₚₜ/Eₚₛ | Eᵥ | Eₚₜ/Eₚₛ | Eᵥ | Eₚₜ/Eₚₛ | Eᵥ | Eₚₜ/Eₚₛ |
| SyNoRiM | 5.76 | 1.37/1.68 | 11.13 | 1.38/1.67 | 18.94 | 1.57/2.76 | 24.05 | 1.61/2.87 |
| Laplacian reg. | 5.04 | 0.65/0.64 | 10.80 | 0.66/0.64 | 18.33 | 0.71/0.73 | 23.71 | 0.73/0.73 |
| 3D-CODED | 11.02 | 2.50/3.31 | 21.19 | 3.01/5.47 | 18.44 | 2.03/5.21 | 24.30 | 2.25/6.33 |
| PCA | 10.24 | 2.62/2.93 | 14.30 | 2.95/3.75 | 15.87 | 3.36/4.10 | 21.12 | 4.10/5.09 |
| Comp. VAE | 5.05 | 0.72/0.78 | 10.74 | 0.73/0.79 | 18.04 | 0.64/0.72 | 23.47 | 0.65/0.74 |
| Ours | 3.58 | 0.58/0.64 | 9.91 | 0.62/0.80 | 15.84 | 0.65/0.77 | 21.55 | 0.73/0.82 |

Table 1 quantitatively demonstrates that the diffusion-based model consistently outperforms SyNoRiM and its heuristic refinement on the metric of vertex error Eᵥ and reasonably outperforms in bidirectional point-to-plane errors Eₚₜ and Eₚₛ. The error metrics in Table 1 may be defined as:

$${E}_{v} = \frac{1}{V} {\sum }_{i = 1}^{V} ‖ {\hat{v}}_{i} - {v}_{i} ‖ \qquad Equation ( 7 )$$

$${E}_{pt} = \frac{1}{V} {\sum }_{i = 1}^{V} ‖ ( {\hat{v}}_{i} - ℜ ( \hat{V} , {v}_{i} ) ) {n}_{{v}_{i}}^{T} ‖ \qquad Equation ( 8 )$$

$${E}_{p s} = \frac{1}{V} {\sum }_{i = 1}^{V} ‖ ( {\hat{v}}_{i} - ℜ ( V , {\hat{v}}_{i} ) ) {n}_{{\hat{v}}_{i}}^{T} ‖ \qquad Equation ( 9 )$$

where Eₚₜ and Eₚₛ indicate the surface-level alignment between the predicted shape and the ground-truth shape. A low E indicates accurate. While having a low point-to-plane error Eₚₜ and Eₚₛ is necessary, low point-to-plane error Eₚₜ and Eₚₛ alone does not provide sufficient conditions for an accurate registration. Table 1 shows that a shape prior generated according to embodiments is more effective than baseline data-driven shape priors. Although the PCA model achieves comparable Eᵥ results to the diffusion model of embodiments on the skirt data, it shows significantly worse plane error Eₚₜ and Eₚₛ. As a linear model, PCA may not be suitable for this inherently nonlinear problem, so it is not flexible enough to achieve accurate surface-level alignment. It cannot fit to large deformations that are far from the mean shape (as shown in FIGS. 9-10) even though they are from the interpolation set and close to some training samples.

Table 2 below is a comparison of the guidance breakpoint i (in Equation (6)) and the impact of varying guidance breakpoint i on the t-shirt sequence.

TABLE 2
Quantitative Impact of Varying Guidance Breakpoint τ

| T-shirt | |
|---|---|
| Interpolation set | Extrapolation set |

| | Eᵥ | Eₚₜ/Eₚₛ | Eᵥ | Eₚₜ/Eₚₛ |
|---|---|---|---|---|
| τ = 40 | 34.86 | 0.74/2.13 | 38.96 | 0.85/3.50 |
| τ = 30 | 4.02 | 0.58/0.66 | 10.03 | 0.62/0.81 |
| τ = 20 | 3.58 | 0.57/0.64 | 9.91 | 0.62/0.80 |
| τ = 10 | 3.66 | 0.58/0.64 | 9.97 | 0.62/0.79 |
| τ = 0 | 3.76 | 0.58/0.64 | 10.03 | 0.61/0.78 |

Table 2 shows that a large guidance breakpoint τ significantly impairs the performance, indicating that the first stage of the guidance framework (i.e., coarse registration guidance 330) plays a key role and is necessary for this instance. When i is in a reasonable range, it does not significantly affect the performance, although r that is too small amplifies the influence of error from the coarse registration. Embodiments outperform both optimization-based and learning-based non-rigid registration methods for both interpolation and extrapolation tests (as shown in Tables 1 and 2).

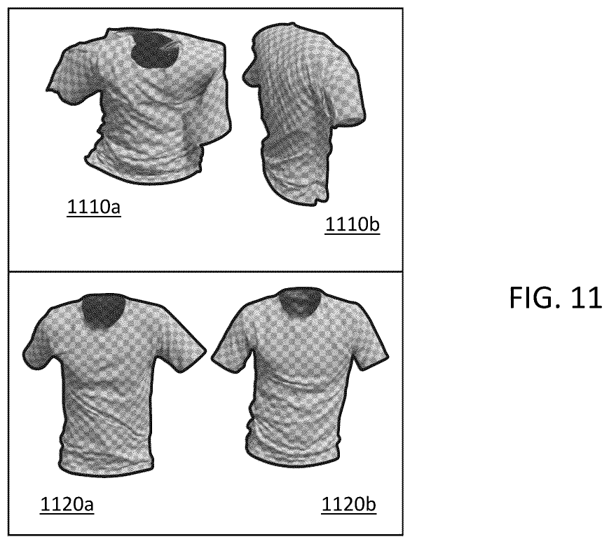

FIG. 11 illustrates background ablation results of the effect of seam stitching, according to embodiments. Registration 1110a and registration 1110b illustrate registrations generated without seam stitching. Without seam stitching, the generated clothing shape has separated parts, as continuity is not enforced across seams. Given a 2D parameterization with multiple islands for the clothing, it is important to enforce the continuity across the seams. The seam stitching (as described with reference to FIG. 5) prevents generating implausible shape with separated clothing parts. Registration 1120a and registration 1120b illustrate registrations generated with seam stitching as disclosed herein. As shown in FIG. 11, the seam stitching ensures continuity across the seams.

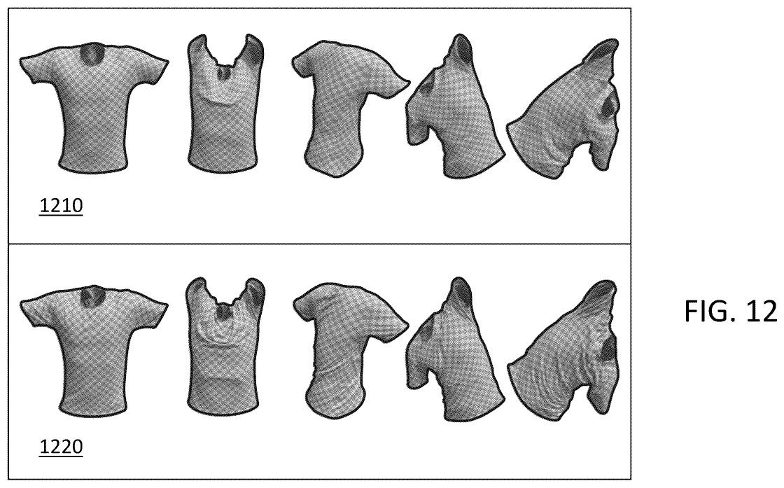

FIG. 12 illustrates background ablation results comparing the difference between predicting data (x₀) and predicting noise (ϵ). Conceptually, it is equivalent to use a data prediction network or a noise prediction network in a diffusion-based model, since one can be derived from the other based on Equation (5), however this is not the case in practice.

Registrations 1210 are based on the data prediction network and registrations 1220 are based on the noise prediction network. The data prediction network has difficulty modeling high-frequency signals like wrinkles. It cannot enforce continuity across the seams even if seam stitching is applied. Therefore, data prediction cannot represent fine details like wrinkles. In contrast, the noise prediction network generates the registrations 1220 including fine details and accurate wrinkle deformations, proving to be more effective.

### Alternative Embodiment

In real-world scenarios, clothing usually comes with textures that make visual keypoint tracking possible. Systems and methods of embodiments can take advantage of such texture information when it is available.

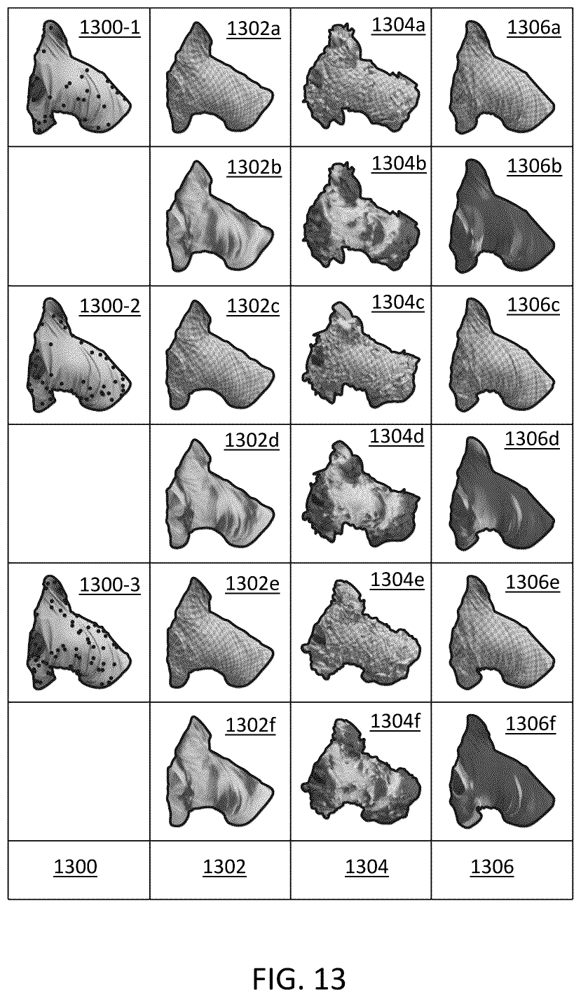

FIG. 13 illustrates registrations generated using sparse ground-truth guidance in a use case where keypoint tracking is available, according to one or more embodiments. As shown in FIG. 13, keypoints 1300 shown as dots in the left column are used for tracking with the number of keypoints which are increasing from top-to-bottom (i.e., 1300-1 has the least number of keypoints, 1300-2 greater number of keypoints, and 1300-3 has the greatest number of keypoints). The t-shirt sequence registrations 1302a, 1302b, 1302c, 1302d, 1302e, and 1302f (hereinafter, collectively referred to as “sparse ground-truth based diffusion model registrations 1302”) are generated according to embodiments. The t-shirt sequence registrations 1304a, 1304b, 1304c, 1304d, 1304e, and 1304f (hereinafter, collectively referred to as “sparse ground-truth PCA registrations 1304”) are generated using the PCA model. The t-shirt sequence registrations 1306a, 1306b, 1306c, 1306d, 1306e, and 1306f (hereinafter, collectively referred to as “sparse ground-truth compositional VAE registrations 1306”) are generated using the VAE model (described with reference to FIG. 8).

Sparse ground-truth guidance may be provided by perfectly accurate sparse texture tracking in scans. In some embodiments, a sparse ground-truth guidance module may replace the coarse registration. The sparse ground-truth guidance module may randomly select Nₖ vertices from the ground-truth mesh (e.g., surfaces 306) and use the Nₖ vertices to compute the distance (defined in Equation (6)) in the first stage of the guidance framework (with t≥τ), as such replacing the coarse registration module 308. By eliminating the need of the coarse registration, any potential error introduced by the module is also removed.

Table 3 below is a comparison of the performance of sparse ground-truth guidance. From Table 3, the data demonstrates that embodiments disclosed here perform well with very sparse keypoint tracking signals and the accuracy improves when the number of sparse keypoints increases.

TABLE 3
Performance of T-Shirt Registrations
with Sparse Ground-Truth Guidance

| T-shirt | |
|---|---|
| Interpolation set | Extrapolation set |

| | Nₖ | Eᵥ | Eₚₜ/Eₚₛ | Eᵥ | Eₚₜ/Eₚₛ |
|---|---|---|---|---|---|
| PCA | 50 | 10.65 | 2.67/3.08 | 13.86 | 2.98/3.87 |
| | 100 | 10.22 | 2.60/2.94 | 13.36 | 2.91/3.72 |
| | 200 | 10.28 | 2.61/2.97 | 13.55 | 2.95/3.78 |
| Comp. | 50 | 30.08 | 1.67/6.00 | 37.16 | 1.45/8.23 |
| VAE | 100 | 28.41 | 1.24/5.94 | 34.55 | 1.07/7.93 |
| | 200 | 25.41 | 1.03/5.67 | 30.54 | 0.87/7.44 |
| Ours | 50 | 4.14 | 0.60/0.74 | 6.71 | 0.66/0.96 |
| | 100 | 2.86 | 0.58/0.66 | 5.39 | 0.64/0.85 |
| | 200 | 2.49 | 0.57/0.65 | 4.96 | 0.63/0.85 |

In Table 3, PCA performs similarly to the original setting in Table 1, while the performance of compositional VAE significantly decreases. Similarly, as shown in FIG. 13, the sparse ground-truth PCA registrations 1304 performs similarly to the original setting (illustrated in FIG. 8) but increasing the number of keypoints does not help. Sparse ground-truth Compositional VAE registrations 1306 fails to learn a meaningful latent space for plausible clothing shapes, because large deformation and fine wrinkles are coupled together, and as such does not find a latent code corresponding to a plausible clothing shape. The sparse ground-truth based diffusion model registrations 1302 demonstrate accurate wrinkles and improved performance over the other models even with sparse tracking signals.

### Hardware Overview

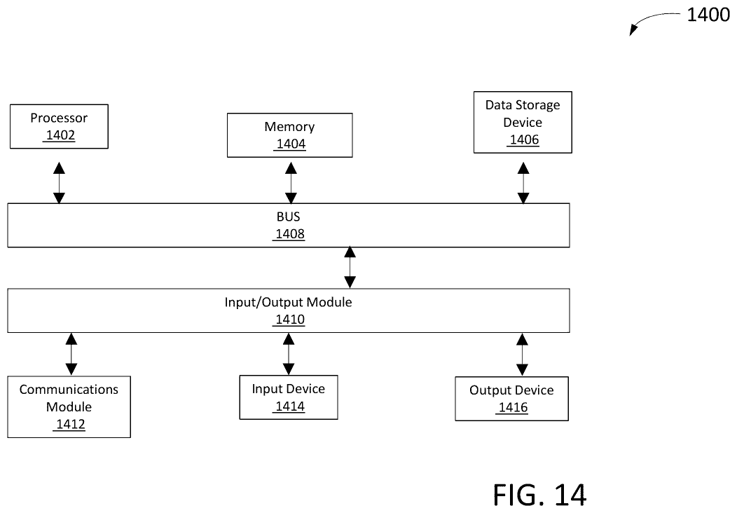

FIG. 14 is a block diagram illustrating an exemplary computer system 1400 with which the client and server of FIGS. 1 and 2, and method(s) described herein can be implemented. In certain aspects, the computer system 1400 may be implemented using hardware or a combination of software and hardware, either in a dedicated server, or integrated into another entity, or distributed across multiple entities. Computer system 1400 may include a desktop computer, a laptop computer, a tablet, a phablet, a smartphone, a feature phone, a server computer, or otherwise. A server computer may be located remotely in a data center or be stored locally.

Computer system 1400 (e.g., client 110 and server 130) includes a bus 1408 or other communication mechanism for communicating information, and a processor 1402 (e.g., processors 212) coupled with bus 1408 for processing information. By way of example, the computer system 1400 may be implemented with one or more processors 1402. Processor 1402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1400 can include, in addition to hardware, code that creates an execution environment for the computer program in question, e.g., code that constitutes processor firmware, a protocol stack, a database management system, an operating system, or a combination of one or more of them stored in an included memory 1404 (e.g., memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1408 for storing information and instructions to be executed by processor 1402. The processor 1402 and the memory 1404 can be supplemented by, or incorporated in, special purpose logic circuitry.

The instructions may be stored in the memory 1404 and implemented in one or more computer program products, e.g., one or more modules of computer program instructions encoded on a computer-readable medium for execution by, or to control the operation of, the computer system 1400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1404 may also be used for storing temporary variable or other intermediate information during execution of instructions to be executed by processor 1402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1400 further includes a data storage device 1406 such as a magnetic disk or optical disk, coupled to bus 1408 for storing information and instructions. Computer system 1400 may be coupled via input/output module 1410 to various devices. Input/output module 1410 can be any input/output module. Exemplary input/output modules 1410 include data ports such as USB ports. The input/output module 1410 is configured to connect to a communications module 1412. Exemplary communications modules 1412 (e.g., communications modules 218) include networking interface cards, such as Ethernet cards and modems. In certain aspects, input/output module 1410 is configured to connect to a plurality of devices, such as an input device 1414 (e.g., input device 214) and/or an output device 1416 (e.g., output device 216). Exemplary input devices 1414 include a keyboard and a pointing device, e.g., a mouse or a trackball, by which a user can provide input to the computer system 1400. Other kinds of input devices 1414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1416 include display devices, such as an LCD (liquid crystal display) monitor, for displaying information to the user.

According to one aspect of the present disclosure, the client device 110 and server 130 can be implemented using a computer system 1400 in response to processor 1402 executing one or more sequences of one or more instructions contained in memory 1404. Such instructions may be read into memory 1404 from another machine-readable medium, such as data storage device 1406. Execution of the sequences of instructions contained in main memory 1404 causes processor 1402 to perform the process steps described herein. One or more processors in a multi-processing arrangement may also be employed to execute the sequences of instructions contained in memory 1404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 1400 can include clients and servers. A client and server are generally remote from each other and typically interact through a communication network. The relationship of client and server arises by virtue of computer programs running on the respective computers and having a client-server relationship to each other. Computer system 1400 can be, for example, and without limitation, a desktop computer, laptop computer, or tablet computer. Computer system 1400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1402 for execution. Such a medium may take many forms, including, but not limited to, non-volatile media, volatile media, and transmission media. Non-volatile media include, for example, optical or magnetic disks, such as data storage device 1406. Volatile media include dynamic memory, such as memory 1404. Transmission media include coaxial cables, copper wire, and fiber optics, including the wires forming bus 1408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method, performed by at least one processor, the method comprising:
obtaining an input scan including at least a cloth;
generating a mesh representing the cloth in the input scan based on a shape prior; and
registering a model of the cloth from the input scan, the registering comprising:
guiding deformation of the cloth based on a coarse registration signal based on the mesh, and
guiding the deformation of the cloth based on a distance between points in the mesh and a template mesh.

2. The computer-implemented method of claim 1, wherein the mesh is represented as a 3D point cloud.

3. The computer-implemented method of claim 1, further comprising mapping each vertex index of the mesh to one or more points in a three-dimensional (3D) surface, wherein the distance from the mesh to the template mesh corresponding to a mean shape is based on the 3D surface.

4. The computer-implemented method of claim 1, wherein the deformation of the cloth is guided based on the coarse registration signal until an alignment of the model with the mesh reaches a threshold.

5. The computer-implemented method of claim 1, further comprising:
determining, based on a current time step, an error in the distance between points in the mesh and the template mesh; and
updating displacements of vertices of the mesh, wherein the deformation of the cloth is guided based on the displacements.

6. The computer-implemented method of claim 1, further comprising generating the coarse registration signal by predicting per-vertex three-dimensional (3D) flow from a mean template shape to the cloth based on the mesh.

7. The computer-implemented method of claim 1, wherein guiding the deformation of the cloth based on the distance between points in the mesh and the template mesh includes refining the model based on point-to-plane errors.

8. The computer-implemented method of claim 1, further comprising:
training a first model based on scans of cloth in motion; and
generating the shape prior based on the first model.

9. The computer-implemented method of claim 8, wherein training the first model includes:
generating mesh representations of the scans of the cloth using parameterization;
gradually adding random noise to the mesh to generate a corrupted map; and
reconstructing the mesh from the random noise based on the corrupted map.

10. The computer-implemented method of claim 1, further comprising:
identifying points that lie in a boundary of the cloth based on the mesh; and
stitching the cloth at the boundary at every time step in the registering.

11. A system, the system comprising:
one or more processors; and
a memory storing instructions which, when executed by the one or more processors, cause the system to:
obtain an input scan including at least a cloth;
generate a mesh representing the cloth in the input scan based on a shape prior;
guide a first deformation of the cloth based on a coarse registration signal based on the mesh;
guide a second deformation of the cloth based on a distance between points in the mesh and a template mesh; and
register a model of the cloth from the input scan based on the first deformation and the second deformation, wherein the first deformation corresponds to large deformations and the second deformation corresponds to detailed deformations.

12. The system of claim 11, wherein the mesh is represented as a 3D point cloud.

13. The system of claim 11, wherein the one or more processors further execute instructions to map each vertex index of the mesh to one or more points in a three-dimensional (3D) surface, wherein the distance from the mesh to the template mesh corresponding to a mean shape is based on the 3D surface.

14. The system of claim 11, wherein the first deformation of the cloth is guided based on the coarse registration signal until an alignment of the model with the mesh reaches a threshold.

15. The system of claim 11, wherein the one or more processors further execute instructions to;
determine, based on a current time step, an error in the distance between points in the mesh and the template mesh; and
update displacements of vertices of the mesh, wherein the deformation of the cloth is guided based on the displacements.

16. The system of claim 11, wherein the one or more processors further execute instructions to generate the coarse registration signal by predicting per-vertex 3D flow from a mean template shape to the cloth based on the mesh.

17. The system of claim 11, wherein the one or more processors further execute instructions to refine the model based on point-to-plane errors determined based on the distance between points in the mesh and the template mesh.

18. The system of claim 11, wherein the one or more processors further execute instructions to:
train a first model based on scans of cloth in motion; and
generate the shape prior based on the first model, wherein training the model includes:
generating mesh representations of the scans using parameterization;
gradually adding random noise to the mesh to generate a corrupted map; and
reconstructing the mesh from the random noise based on the corrupted map.

19. The system of claim 18, wherein the one or more processors further execute instructions to:
identify points that lie in a boundary of the cloth based on the mesh; and
stitch the cloth at the boundary at every time step in the registering.

20. A non-transient computer-readable storage medium having instructions embodied thereon, the instructions being executable by one or more processors to perform a method for cloth registration and cause the one or more processors to:
obtain an input scan including at least a clothing;
generate a mesh representing the clothing in the input scan based on a shape prior;
guide a first deformation of the clothing based on a coarse registration signal and 3D point cloud corresponding to the mesh;
guide a second deformation of the clothing based on a distance between points in the 3D point cloud and a template mesh; and
register a model of the clothing from the input scan based on the first deformation and the second deformation, wherein the first deformation corresponds to large deformations and the second deformation corresponds to detailed deformations.
